(19) United States
(12) Patent Application Publication
(10) Pub. No.: US 2026/0216707 A1
(43) Pub. Date: Jul. 30, 2026

(54) SULFUR POISONING-RESISTANT CATALYST FOR CATALYTIC COMBUSTION, PREPARATION METHOD THEREFOR, AND USE THEREOF

(71) Applicants: GUANGDONG UNIVERSITY OF TECHNOLOGY, Guangzhou (CN); NANCHANG UNIVERSITY, Nanchang (CN)

(72) Inventors: Taicheng AN, Guangzhou (CN); Yuni YIN, Guangzhou (CN); Honggen PENG, Nanchang (CN); Hongli LIU, Guangzhou (CN)

(73) Assignees: GUANGDONG UNIVERSITY OF TECHNOLOGY, Guangzhou (CN); NANCHANG UNIVERSITY, Nanchang (CN)

(21) Appl. No.: 19/157,368

(22) PCT Filed: Dec. 19, 2023
(86) PCT No.: PCT/CN2023/139922

§ 371 Date: Aug. 17, 2025

(30) Foreign Application Priority Data
Feb. 24, 2023 (CN) 202310173106.0

(51) Int. Cl. B01J 23/89; B01D 53/86; B01J 21/10; B01J 37/02; B01J 37/12

(52) U.S. Cl. CPC B01J 23/8926; B01D 53/8609; B01J 21/10; B01J 37/0213; B01J 37/12; B01D 2257/302

(57) ABSTRACT

A sulfur poisoning-resistant catalyst for catalytic combustion and a preparation method therefor and use thereof are provided. A specific second metal and a precious metal are reduced and uniformly dispersed by adopting a polyol reduction method, and the two metals are loaded onto a catalyst carrier by employing wet impregnation, so that the two metals can be dependent on each other to form an active interface. On the basis that a second metal sulfate has higher thermal stability, a sulfide in an industrial organic waste gas is more prone to being combined with the second metal. Therefore, in the sulfur poisoning-resistant catalyst for catalytic combustion prepared by adopting the preparation method provided by the present invention, the second metal can play a role of protecting the precious metal from sulfur poisoning.

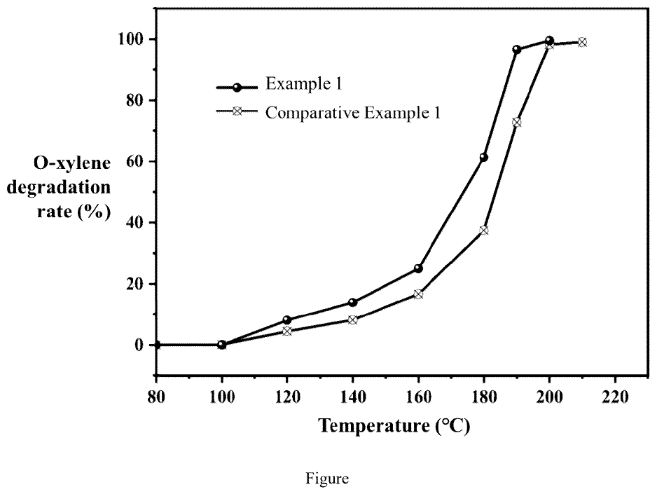

### CROSS REFERENCE TO THE RELATED APPLICATIONS

This application is the national phase entry of International Application No. PCT/CN2023/139922, filed on Dec. 19, 2023, which is based upon and claims priority to Chinese Patent Application No. 202310173106.0, filed on Feb. 24, 2023, the entire contents of which are incorporated herein by reference.

### TECHNICAL FIELD

The present invention belongs to the field of waste gas treatment, and specifically relates to a sulfur poisoning-resistant catalyst for catalytic combustion and a preparation method therefor and use thereof.

### BACKGROUND

Volatile organic compounds (VOCs) in industrial organic waste gas have serious harm to the atmospheric environment and human health. Therefore, removal of the VOCs from the industrial organic waste gas is a hot topic in the field of air pollution prevention and control.

In recent years, a catalytic combustion technology has been widely used in efficient treatment of the VOCs in the industrial organic waste gas because of a series of advantages such as low initiation temperature, low energy consumption, good low-temperature catalytic activity, high treatment efficiency, no generation of by-products and recycling of a catalyst. A high-performance catalyst is a core of the catalytic combustion technology. Precious metal catalysts have superior catalytic activity and stability for combustion of aliphatic hydrocarbons and aromatic hydrocarbons in the VOCs. However, precious metals have scarce resources and expensive prices, leading to higher prices of the precious metal catalysts. Meanwhile, the precious metals are prone to being combined with a sulfide in sulfur-containing industrial organic waste gas, leading to poisoning of the catalysts and decrease of catalytic activity. Thus, wide applications of the precious metal catalysts are limited.

A catalytic combustion catalyst with a core-shell structure and a preparation method therefor are disclosed in the prior art. A precious metal oxide as an active component of the catalyst is encapsulated in a shell composed of SiO₂ and a transition metal oxide, and the transition metal oxide in the shell is utilized to adsorb the sulfide in the industrial organic waste gas, thereby improving the sulfur resistance stability of the catalyst. Meanwhile, it can also ensure decreased loss of a precious metal during use. However, the catalyst provided in the prior art has a higher content of the precious metal, thereby increasing the preparation cost of the catalyst. Meanwhile, a principle capable of reducing sulfur poisoning of the precious metal in the prior art lies in that the precious metal is protected in the form of encapsulation. However, active sites are not fully exposed after the precious metal is encapsulated by a shell layer, and meanwhile, the presence of the shell layer also hinders mass transfer in a catalytic reaction process, thereby greatly affecting the catalytic activity of the catalyst.

### SUMMARY

To solve the problems that precious metal catalysts used for catalytic combustion of industrial organic waste gas in the prior art are prone to generating sulfur poisoning and means for protecting precious metals are likely to affect the activity of the catalysts, the present invention provides a preparation method for a sulfur poisoning-resistant catalyst for catalytic combustion. A second metal is used as a “sacrificial agent” to transfer irreversible poisoning of a precious metal in a sulfur poisoning treatment process, thereby ensuring the catalytic activity of the catalyst while decreasing a use amount of the precious metal.

Another objective of the present invention is to provide a sulfur poisoning-resistant catalyst for catalytic combustion.

Another objective of the present invention is to provide use of the above sulfur poisoning-resistant catalyst for catalytic combustion in treatment of waste gas.

The above objectives of the present invention are achieved through the following technical solutions.

A preparation method for a sulfur poisoning-resistant catalyst for catalytic combustion specifically includes the following steps:

S1. separately dissolving a precious metal salt and a second metal salt in water to obtain a precious metal salt solution and a second metal salt solution;

S2. adding polyvinylpyrrolidone into a polyol, and simultaneously adding the precious metal salt solution and the second metal salt solution into the polyol to carry out a reaction to obtain a sol or a solution, wherein a molar ratio of a precious metal element in the precious metal salt solution to a second metal element in the second metal salt solution is (0.1-9):1; and
S3. fully mixing the sol or the solution obtained in the step S2, a catalyst carrier powder and an organic solvent to load a precious metal component and a second metal component onto the catalyst carrier, and conducting drying and calcination to obtain a sulfur poisoning-resistant catalyst for catalytic combustion;
wherein the second metal salt is arbitrarily selected from one or more of salts of Cu, Zn, Co, and Fe; and
the catalyst carrier is magnesia-alumina spinel.

In the step S2 of the above preparation method, a reaction method adopted is a polyol reduction method. In the step S2, the polyol first serves as an organic solvent to provide an occasion for dispersion of precious metal ions and second metal ions and the reduction reaction of some ions. Secondly, the polyol can serve as a weak reducing agent to partially reduce the precious metal component and the second metal component to obtain elemental nanoparticles of the precious metal and the second metal. The precious metal nanoparticles and the second metal nanoparticles can serve as active components of the sulfur poisoning-resistant catalyst for catalytic combustion prepared by the present invention, because d orbital electrons of the two metal elements are unfilled and are capable of bonding to a catalytic substrate to form a reaction intermediate with activity.

A reaction method adopted in the step S3 is wet impregnation. In the step S3, after the sol or the solution obtained in the S2 is added into the organic solvent, the resulting solution system contains the ions and nanoparticles of the precious metal and the second metal. Meanwhile, when the catalyst carrier is added into the solution system and fully mixed, the nanoparticles and ions of the precious metal and the second metal can be loaded onto the catalyst carrier. This is firstly because the magnesia-alumina spinel having a high specific surface area and a resulting high adsorption capacity are capable of adsorbing the nanoparticles of the two metals. Secondly, during the mixing, the ions of the two metals can migrate vigorously with the help of a flowing liquid phase to generate an electrostatic interaction with the catalyst carrier such as the solid-phase magnesia-alumina spinel. Therefore, through the wet impregnation, the precious metal component and the second metal component can be loaded onto the catalyst carrier. The reason why the ions of the two metals can generate the electrostatic interaction with the catalyst carrier is that a unit cell of the magnesia-alumina spinel is composed of O²⁻ closely packed octahedrons and tetrahedrons, Al³⁺ in gaps of the octahedrons, and magnesium ions Mg²⁺ in gaps of the tetrahedrons, wherein O²⁻ can attract the positively charged precious metal ions and second metal ions through an electrostatic effect, and such attraction is also conducive to generating an active interface that promotes changes in an existence form of an oxygen element.

The polyvinylpyrrolidone, namely PVP, in the step S2 functions as a dispersant. PVP molecules have hydrophilic ends and hydrophobic ends, and thus, the polyvinylpyrrolidone can be used as the dispersant to disperse the metal nanoparticles reduced by the polyol. Moreover, hydrophobic groups of the PVP have quite large volumes, a certain electrostatic repulsive force can also be generated between hydrophobic carbon chains of different PVP molecules, and the superposition of a steric hindrance effect and a charge effect can further prevent aggregation of the metal ions or particles in the system. Secondly, the PVP can promote formation of the active interface that promotes changes in the existence form of the oxygen element between the precious metal and the second metal. The PVP molecules contain oxygen-containing groups, oxygen atoms of the oxygen-containing groups have lone pair electrons, and the lone pair electrons can simultaneously adsorb the positively charged precious metal ions and second metal ions. However, after the two metal ions are reduced into metal particles through subsequent steps, the precious metal particles and the second metal particles still have an adsorption effect formed with the help of the lone pair electrons on the oxygen atoms. Due to such adsorption effect, the two metal particles have an interaction to form the active interface, and the active interface can promote changes in the existence form of the oxygen element.

The above active interface that can promote changes in the existence form of the oxygen element has an effect of promoting transformation of the oxygen element between two existence forms including chemically adsorbed oxygen and lattice oxygen. In the catalyst prepared by adopting the preparation method for a sulfur poisoning-resistant catalyst for catalytic combustion provided by the present invention, the precious metal nanoparticles and the second metal nanoparticles that serve as the active components contain a certain amount of the oxygen element. The oxygen element has two existence forms in the metals, including lattice oxygen and chemically adsorbed oxygen, respectively. The lattice oxygen plays a major role in a catalytic combustion process. After the lattice oxygen participates in a reaction, the metals near oxygen sites are reduced into lower valence states. At this time, the chemically adsorbed oxygen can oxidize the metals in the lower valence states, and the chemically adsorbed oxygen is transformed into the lattice oxygen to supplement the catalytic activity of the metals. The reason why the interaction between the second metal and the precious metal can form the active interface that promotes changes in the existence form of the oxygen element is that the second metal has a higher content of the chemically adsorbed oxygen, and the precious metal has a higher content of the lattice oxygen. After the two metals interact to form the interface, when the lattice oxygen in the precious metal is consumed, the chemically adsorbed oxygen in the second metal can be rapidly transformed into the lattice oxygen in the precious metal through the active interface between the two metals. According to experimental measurements, the sulfur poisoning-resistant catalyst loaded with the two active components including the precious metal and the second metal provided by the present invention has an oxygen desorption temperature shifted to a lower temperature compared with a catalyst with only a precious metal as an active component, and that is to say, oxygen can be desorbed from the catalyst at a lower temperature. In addition, according to analysis of a chemical state of the oxygen element, a ratio of the chemically adsorbed oxygen to the lattice oxygen on the catalyst is also increased with addition of the second metal.

In the step S2, the molar ratio of the precious metal element in the precious metal salt solution to the second metal element in the second metal salt solution is limited to (0.1-9):1, which is first used to exert the role of the second metal as the “sacrificial agent” to a maximum extent. In the sulfur poisoning-resistant catalyst for catalytic combustion prepared by adopting the preparation method for a sulfur poisoning-resistant catalyst for catalytic combustion provided by the present invention, a thermal decomposition temperature of a second metal sulfate is higher than that of a precious metal sulfate, correspondingly, thermal stability of the second metal sulfate is also higher, and a sulfide has a greater tendency to react with the second metal. Thus, the second metal can play the roles of protecting the precious metal and preventing the precious metal from sulfur poisoning. Secondly, controlling use amounts of the precious metal component and the second metal component within the above ranges can decrease the use amount of the precious metal while ensuring the catalytic activity of the catalyst, thereby controlling the preparation cost of the catalyst.

The second metal salt is limited to one or more of the salts of Cu, Zn, Co, and Fe. First, because the four second metals are more prone to being combined with the sulfide in industrial organic waste gas to generate sulfates compared with the precious metal, thereby protecting the precious metal from being poisoned by the sulfide. In addition, according to the sulfur poisoning-resistant catalyst for catalytic combustion constructed by adopting the four second metal elements and the precious metal together, by regulating a ratio of the second metal elements to the precious metal element, the performance of the catalyst in catalyzing combustion of VOCs can be almost the same as that of a catalyst using only a precious metal as an active component. This is because the four elements including Cu, Zn, Co and Fe have rich and variable valence states, which are conducive to forming more oxygen vacancies in the catalyst and improving the catalytic activity of the catalyst. Meanwhile, the four second metal elements are also conducive to generating the active interface that promotes changes in the existence form of the oxygen element, and the catalytic activity of the formed sulfur poisoning-resistant catalyst for catalytic combustion can also be improved.

The magnesia-alumina spinel is used as the carrier of the sulfur poisoning-resistant catalyst for catalytic combustion, because the magnesia-alumina spinel has the higher specific surface area, and O²⁻ in lattices can attract the positively charged precious metal ions and second metal ions through the electrostatic effect.

Preferably, the precious metal salt in the step S1 is arbitrarily selected from one or more of salts of Pt, Pd, Ru, Rh, and Au.

Precious metal catalysts with silver and other precious metals as main active components have the disadvantage of poor stability, and meanwhile, the catalytic activity of the precious metal catalysts is incomparable to other precious metals even in a case of a larger loading amount (>1%).

In a specific embodiment of the present invention, the precious metal salt and the second metal salt are a tetraamine precious metal nitrate or a precious metal trichloride and a second metal nitrate, respectively.

Preferably, a temperature of the reaction in the step S2 is 100-200° C.

Preferably, the molar ratio of the precious metal element in the precious metal salt solution to the second metal element in the second metal salt solution in the step S2 is (0.428-2.3):1.

When the ratio of the two metals is within the range of (0.428-2.3):1, the catalyst has better sulfur poisoning resistance, and the cost of the catalyst is also lower.

Preferably, a total loading amount of the precious metal and the second metal in the sulfur poisoning-resistant catalyst obtained in the step S3 is 0.1 wt %-1 wt %.

A ratio of a total mass of the precious metal and the second metal in the sol to a mass of the catalyst carrier powder is limited within the above range, because when the total loading amount of the two metals is 0.1%-1%, the sulfur poisoning-resistant catalyst for catalytic combustion provided by the present invention also has a lower cost while having excellent activity.

Preferably, a molar ratio of a magnesium element to an aluminum element in the magnesia-alumina spinel in the step S3 is 1:(2-3).

The molar ratio of the magnesium element to the aluminum element in the magnesia-alumina spinel is preferred, because when the magnesium-aluminum ratio in the magnesia-alumina spinel is 1:(2-3), the magnesia-alumina spinel has the higher specific surface area, which is conducive to adsorption and dispersion of the precious metal component and the second metal component. Meanwhile, because the unit cell of the magnesia-alumina spinel is composed of O²⁻ closely packed octahedrons and tetrahedrons, Al³⁺ in gaps of the octahedrons, and magnesium ions Mg²⁺ in gaps of the tetrahedrons, the molar ratio of the magnesium element to the aluminum element affects the crystal phase composition and strength of the magnesia-alumina spinel. Moreover, lattice defects generated in the magnesia-alumina spinel are also affected by the ratio of the magnesium element to the aluminum element and ultimately affect electron densities of the two active components including the precious metal and the second metal.

Preferably, a temperature of the calcination in the step S3 is 200-500° C.

Preferably, a time of the calcination is 2-5 h.

By controlling the temperature and time of the calcination within the above ranges respectively, not only can auxiliary materials added in an early preparation stage of the catalyst be decomposed more completely to remove chemically bound water and volatile impurities more thoroughly, but also the catalyst can be activated simultaneously, thereby enhancing the interaction between the active components of the catalyst and the carrier, making the active components less prone to migration or aggregation, and ensuring the activity of the catalyst.

Preferably, in the step S3, a reducing gas is introduced for reduction after the calcination.

After the calcination, the reducing gas introduced for reduction can further reduce a part of the precious metal element and the second metal element that are not reduced by the polyol in the step S2, thereby enhancing a reduction effect, and ensuring that the catalyst has higher catalytic activity.

More preferably, a temperature of the reduction is 200-500° C.

More preferably, a time of the reduction is 2-5 h.

The present invention further protects a sulfur poisoning-resistant catalyst for catalytic combustion, wherein the sulfur poisoning-resistant catalyst is prepared by the above preparation method for a sulfur poisoning-resistant catalyst for catalytic combustion.

The present invention further protects use of the above sulfur poisoning-resistant catalyst for catalytic combustion in treatment of waste gas.

In a specific embodiment of the present invention, pollutant molecules contained in the above waste gas may be volatile organic compounds such as methane, propane, toluene, xylene, or ethyl acetate.

Preferably, the above waste gas is sulfur-containing industrial organic waste gas.

According to the sulfur poisoning-resistant catalyst for catalytic combustion prepared by the present invention, the second metal is used as the “sacrificial agent” for the precious metal to protect the precious metal, so that the precious metal is less prone to being combined with the sulfide in the industrial organic waste gas. Therefore, when the catalyst provided by the present invention is used for catalyzing combustion of the sulfur-containing industrial organic waste gas, excellent sulfur resistance of the catalyst can be better shown.

More preferably, a content of sulfur dioxide in the above sulfur-containing industrial organic waste gas is 1-200 ppm.

According to the present invention, when combustion and conversion of the sulfur dioxide in the sulfur-containing industrial organic waste gas are catalyzed, the temperature at which the combustion and conversion of a catalytic substrate reach 90% is used to characterize the catalytic activity of the sulfur poisoning-resistant catalyst for catalytic combustion before and after sulfur treatment. When the content of the sulfur dioxide in the sulfur-containing industrial organic waste gas is 1-200 ppm, the catalytic activity of the sulfur poisoning-resistant catalyst for catalytic combustion provided by the present invention is basically unchanged and is at a level below 200° C. When the content of the sulfur dioxide in the sulfur-containing industrial organic waste gas is lower than 1 ppm, the sulfide in the waste gas has an inapparent poisoned effect on the precious metal, so that the practicability of the sulfur poisoning-resistant catalyst for catalytic combustion provided by the present invention is reduced. When the content of the sulfur dioxide is higher than 200 ppm, the catalyst provided by the present invention is prone to having decreased activity due to the combination of the precious metal and the sulfide.

Compared with the prior art, the present invention has the following beneficial effects.

In the present invention, the two methods including polyol reduction and wet impregnation are adopted, the precious metal and the second metal as the “sacrificial agent” are loaded onto the carrier such as the magnesia-alumina spinel with the high specific surface area by adopting the PVP as the dispersant, and the active interface that can promote changes in the existence form of the oxygen element exists between the two metals. On one hand, not only is the use amount of the precious metal decreased, but also the catalytic activity of the catalyst is ensured, and the preparation cost of the catalyst is controlled. On the other hand, the second metal used as the sacrificial agent transfers irreversible poisoning of the precious metal during sulfur poisoning treatment. The sulfur poisoning-resistant catalyst for catalytic combustion prepared by adopting the preparation method provided by the present invention can catalyze combustion and degradation of the sulfur-containing industrial organic waste gas with the sulfur dioxide content as high as 200 ppm at a lower temperature. Moreover, the catalytic activity is almost unchanged before and after a catalytic combustion process of the sulfur-containing industrial organic waste gas.

### BRIEF DESCRIPTION OF THE DRAWINGS

FIGURE shows a diagram of catalytic activity of sulfur poisoning-resistant catalysts for catalytic combustion provided in Example 1 and Comparative Example 1 of the present invention.

### DETAILED DESCRIPTION OF THE EMBODIMENTS

The present invention is further illustrated below in combination with specific embodiments, but examples do not constitute limitations to the present invention in any manner. Unless otherwise specified, raw materials and reagents used in the examples of the present invention are conventionally purchased raw materials and reagents.

### Example 1

A preparation method for a sulfur poisoning-resistant catalyst for catalytic combustion specifically includes the following steps:
S1. separately dissolving tetraammineplatinum nitrate and ferric nitrate in water to reach constant volumes to formulate a 0.02 mol/L platinum salt solution and an iron salt solution, respectively;
S2. adding 0.04 mol of PVP into ethylene glycol, and simultaneously adding the platinum salt solution and the iron salt solution into the ethylene glycol to carry out a reaction to obtain a sol, wherein a molar ratio of a platinum element in the platinum salt solution to an iron element in the iron salt solution was n_{Pt}:n_{Fe}=5:5; and
S3. mixing the sol obtained in the step S2, a magnesia-alumina spinel powder and anhydrous ethanol, wherein a molar ratio of a magnesium element to an aluminum element in the magnesia-alumina spinel was 1:3; conducting stirring at room temperature for 6 h, then evaporating the excessive ethanol to dryness at 80° C., and conducting drying overnight; then, raising the temperature to 300° C. at 2° C./min, and conducting calcination for 3 h to obtain a solid powder; and finally, introducing a reducing atmosphere obtained by mixing H₂ and Ar to conduct reduction at 300° C. for 3 h to obtain the sulfur poisoning-resistant catalyst for catalytic combustion, wherein a total loading amount of platinum and iron in the obtained sulfur poisoning-resistant catalyst was 0.2 wt %.

### Example 2

A preparation method for a sulfur poisoning-resistant catalyst for catalytic combustion was different from Example 1 in that:
S2. a molar ratio of a platinum element in a platinum salt solution to an iron element in an iron salt solution was n_{Pt}:n_{Fe}=011:1.

### Example 3

A preparation method for a sulfur poisoning-resistant catalyst for catalytic combustion was different from Example 1 in that:
S2. a molar ratio of a platinum element in a platinum salt solution to an iron element in an iron salt solution was n_{Pt}:n_{Fe}=9:1.

### Example 4

A preparation method for a sulfur poisoning-resistant catalyst for catalytic combustion was different from Example 1 in that:
S2. a molar ratio of a platinum element in a platinum salt solution to an iron element in an iron salt solution was n_{Pt}:n_{Fe}=0.428:1.

### Example 5

A preparation method for a sulfur poisoning-resistant catalyst for catalytic combustion was different from Example 1 in that:
S2. a molar ratio of a platinum element in a platinum salt solution to an iron element in an iron salt solution was n_{Pt}:n_{Fe}=2.3:1.

### Example 6

A preparation method for a sulfur poisoning-resistant catalyst for catalytic combustion was different from Example 1 in that:
S1. tetraamminepalladium nitrate and copper nitrate were separately dissolved in water to formulate a palladium salt solution and a copper salt solution.

### Example 7

A preparation method for a sulfur poisoning-resistant catalyst for catalytic combustion was different from Example 1 in that:
S1. rhodium trichloride and cobalt nitrate were separately dissolved in water to formulate a rhodium salt solution and a cobalt salt solution.

### Example 8

A preparation method for a sulfur poisoning-resistant catalyst for catalytic combustion was different from Example 1 in that:
S1. ruthenium trichloride and zinc nitrate were separately dissolved in water to formulate a ruthenium salt solution and a zinc salt solution.

### Example 9

A preparation method for a sulfur poisoning-resistant catalyst for catalytic combustion was different from Example 1 in that:
S1. gold trichloride and ferric nitrate were separately dissolved in water to formulate a gold salt solution and an iron salt solution.

### Example 10

A preparation method for a sulfur poisoning-resistant catalyst for catalytic combustion was different from Example 1 in that:
S3. a total loading amount of a precious metal and a second metal in the obtained sulfur poisoning-resistant catalyst was 0.01 wt %.

### Example 11

A preparation method for a sulfur poisoning-resistant catalyst for catalytic combustion was different from Example 1 in that:
S3. a total loading amount of a precious metal and a second metal in the obtained sulfur poisoning-resistant catalyst was 0.1 wt %.

### Example 12

A preparation method for a sulfur poisoning-resistant catalyst for catalytic combustion was different from Example 1 in that:
S3. a total loading amount of a precious metal and a second metal in the obtained sulfur poisoning-resistant catalyst was 1 wt %.

### Example 13

A preparation method for a sulfur poisoning-resistant catalyst for catalytic combustion was different from Example 1 in that:
S3. a molar ratio of a magnesium element to an aluminum element in magnesia-alumina spinel was 1:4.

### Example 14

A preparation method for a sulfur poisoning-resistant catalyst was different from Example 1 in that:
S3. a molar ratio of a magnesium element to an aluminum element in magnesia-alumina spinel was 1:2.

### Example 15

A preparation method for a sulfur poisoning-resistant catalyst for catalytic combustion was different from Example 1 in that:
S3. a molar ratio of a magnesium element to an aluminum element in magnesia-alumina spinel was 1:1.

### Comparative Example 1

A preparation method for a sulfur poisoning-resistant catalyst for catalytic combustion was different from Example 1 in that:
S2. only a platinum salt solution was added into ethylene glycol to carry out a reaction.

### Comparative Example 2

A preparation method for a sulfur poisoning-resistant catalyst for catalytic combustion was different from Example 1 in that:
S2. a molar ratio of a platinum element in a platinum salt solution to an iron element in an iron salt solution was nₚₜ:n_{Fe}=10:1.

### Comparative Example 3

A preparation method for a sulfur poisoning-resistant catalyst for catalytic combustion was different from Example 1 in that:
S2. a molar ratio of a platinum element in a platinum salt solution to an iron element in an iron salt solution was n_{Pt}:n_{Fe}=0.05:1.

### Performance Tests

Catalytic combustion activity test: 50 mg of the sulfur poisoning-resistant catalysts for catalytic combustion provided in Examples 1-12 of the present invention were taken and filled into quartz reaction tubes, the temperature was controlled with a thermocouple, and a constant temperature test was carried out after the temperature was raised at 2° C. min⁻¹ in a range of 50-500° C., wherein a reaction gas was a 1,000 ppm o-xylene gas obtained by bubbling and diluting o-xylene with air, a total reaction gas flow rate was controlled at 30 mL/min, and an air velocity was 36,000 mL·g_{cat.}⁻¹ h⁻¹. A reaction tail gas was introduced into a gas chromatograph for analysis. The temperature (T₉₀) at which degradation of the reaction gas reached 90% was used to characterize the catalytic combustion activity of the catalysts, and the lower T₉ indicated better catalytic combustion activity of the catalysts.

Sulfur poisoning resistance test: 50 mg of the sulfur poisoning-resistant catalysts provided in Examples 1-12 of the present invention were taken and filled into quartz reaction tubes, and after the temperature was raised to a constant temperature of 200° C. at 2° C.·min⁻¹, 200 ppm SO₂ and 16% of a mixed gas of O₂ and N₂ were introduced to conduct sulfurization treatment for 3 h, wherein a total mixed gas flow rate was controlled at 50 ml/min, and an air velocity was 60,000 mL·g_{cat.}⁻¹ h⁻¹. Then, an H₂/Ar gas flow was introduced into the catalysts after the sulfurization treatment to conduct reduction at 300° C. for 3 h, and the catalysts were used in a catalytic combustion test of o-xylene.

A calculation formula for a reaction gas degradation rate (X_{VOCs}) is as follows:

$${X}_{VOCs} = \frac{{[ VOCs ]}_{in} - {[ VOCs ]}_{out}}{{[ VOCs ]}_{in}} \times 100 \%$$

Performance test data are shown in Tables 1-2 and FIGURE below.

TABLE 1
Comparison of experimental settings in examples and comparative examples

| | | | | Total loading | |
|---|---|---|---|---|---|
| | | | | amount of precious | n_{Mg}:n_{A1} in |
| | Precious | Second | | metal and second | magnesia-alumina |
| | metal | metal | n_{precious metal}:n_{second metal} | metal % | spinel |
| Example 1 | Pt | Fe | 1:1 | 0.2 | 1:3 |
| Example 2 | Pt | Fe | 0.11:1 | 0.2 | 1:3 |
| Example 3 | Pt | Fe | 9:1 | 0.2 | 1:3 |
| Example 4 | Pt | Fe | 0.428:1 | 0.2 | 1:3 |
| Example 5 | Pt | Fe | 2.3:1 | 0.2 | 1:3 |
| Example 6 | Pd | Cu | 1:1 | 0.2 | 1:3 |
| Example 7 | Rh | Co | 1:1 | 0.2 | 1:3 |
| Example 8 | Ru | Zn | 1:1 | 0.2 | 1:3 |
| Example 9 | Au | Fe | 1:1 | 0.2 | 1:3 |
| Example 10 | Pt | Fe | 1:1 | 0.01 | 1:3 |
| Example 11 | Pt | Fe | 1:1 | 0.1 | 1:3 |
| Example 12 | Pt | Fe | 1:1 | 1 | 1:3 |
| Example 13 | Pt | Fe | 1:1 | 0.2 | 1:4 |
| Example 14 | Pt | Fe | 1:1 | 0.2 | 1:2 |
| Example 15 | Pt | Fe | 1:1 | 0.2 | 1:1 |
| Comparative | Pt | / | / | 0.2 | 1:3 |
| Example 1 | | | | | |
| Comparative | Pt | Fe | 10:1 | 0.2 | 1:3 |
| Example 2 | | | | | |
| Comparative | Pt | Fe | 0.05:1 | 0.2 | 1:3 |
| Example 3 | | | | | |

TABLE 2
Comparison of data in examples and comparative examples

| | T₉₀ before sulfur | T₉₀ after sulfur |
|---|---|---|
| | treatment/° C. | treatment/° C. |
| Example 1 | 193 | 188 |
| Example 2 | 258 | 270 |
| Example 3 | 179 | 195 |
| Example 4 | 215 | 221 |
| Example 5 | 187 | 197 |
| Example 6 | 228 | 239 |
| Example 7 | 237 | 244 |
| Example 8 | 242 | 258 |
| Example 9 | 304 | 309 |
| Example 10 | 276 | 286 |
| Example 11 | 223 | 231 |
| Example 12 | 167 | 171 |
| Example 13 | 202 | 215 |
| Example 14 | 210 | 213 |
| Example 15 | 223 | 229 |
| Comparative Example 1 | 178 | 197 |
| Comparative Example 2 | 178 | 199 |
| Comparative Example 3 | 284 | 301 |

According to the sulfur poisoning-resistant catalyst for catalytic combustion provided in Example 1 of the present invention, the temperature at which the catalytic degradation of o-xylene reaches a conversion rate of 90% is 193° C. Compared with the general prior art, the temperature required for catalytic combustion is lower, that is, the activity is higher. After the treatment with the sulfur-containing gas with the sulfur dioxide content as high as 200 ppm, the temperature at which the catalyst catalyzes the o-xylene to achieve a degradation rate of 90% is basically unchanged, indicating that the catalyst has an excellent ability to resist sulfur poisoning.

In Examples 2-5, different catalysts are obtained by maintaining the total loading amount of the active components unchanged at 0.2 wt % and changing the molar ratio of the precious metal to the second metal. It can be seen from the data in Examples 1-5 that the initial catalytic activity of the catalysts is obviously positively correlated with changes in the proportion of Pt, and when the relative content of Pt is higher, the initial catalytic activity of the sulfur poisoning-resistant catalysts for catalytic combustion is better. However, after the sulfur treatment, the catalytic activity of the catalysts provided in Examples 1-5 is firstly increased and then decreased with relative increase of the content of Pt. When the molar ratio of the precious metal to the second metal in the catalysts is the preferred (0.428-2.3):1 in the present invention, the catalysts have both higher catalytic activity and sulfur poisoning resistance.

In Examples 6-9, the types of the precious metal element and the second metal element in Example 1 are changed. The test results show that in the case of a same content, the Pt—Fe dual-component catalyst has best catalytic performance and also exhibits better sulfur resistance.

In Examples 10-12, the loading amount of the active components in Example 1 is changed. The test results show that when the loading amount of the precious metal and the second metal is lower, the activity of the catalyst in catalyzing combustion of the o-xylene is decreased (shown as increase in T₉₀). However, when the loading amount of the active components in the catalyst is increased to 1 wt %, an effect of improving the catalytic activity of the catalyst is decreased, and the preparation cost of the catalyst is increased.

In Examples 13-15, the molar ratio of the magnesium element to the aluminum element in the magnesia-alumina spinel as the catalyst carrier in Example 1 is changed. When the magnesium-aluminum ratio in the magnesia-alumina spinel is the preferred 1:(2-3) in the present invention, the T₉₀ of the catalyst is lower, indicating that the catalytic activity of the catalyst is higher, which is caused by the larger specific surface area of the magnesia-alumina spinel.

In Comparative Example 1 serving as an extreme case, the catalyst prepared by only adding the single Pt is provided. The mass fraction of Pt in the catalyst is higher than that of Pt in Example 1, so that the initial catalytic activity of the catalyst is also higher. The temperature at which the catalytic degradation of o-xylene reaches 90% is 15° C. lower than that of the catalyst in Example 1. However, after the catalyst in Comparative Example 1 is subjected to the sulfurization treatment, the temperature at which the catalytic degradation of o-xylene reaches a conversion rate of 90% is increased by about 20° C., the catalytic activity is greatly decreased, and the sulfur poisoning resistance is far inferior to that of the catalyst provided in Example 1. Meanwhile, the cost of the active component of the catalyst in Comparative Example 1 is higher, which is not conducive to putting the catalyst in large-scale industrial application.

FIGURE shows activity comparison curves of the catalysts after the sulfur treatment in Example 1 and Comparative Example 1. It can be seen that the T₉₀ temperature at which the catalyst in Example 1 (solid-dotted curve) catalyzes the o-xylene to achieve a conversion rate of 90% is 188° C., and the T₉₀ temperature of the catalyst in Comparative Example 1 (hollow-dotted curve) is 297° C. That is to say, after the sulfur poisoning treatment, the catalytic activity of the catalyst in Example 1 is better than that in Comparative Example 1, indicating that the catalyst in Example 1 of the present invention has better sulfur resistance than that in Comparative Example 1, which indicates the necessity of loading the second metal in the catalyst of the present invention.

Obviously, the above examples of the present invention are only instances provided to clearly illustrate the present invention and are not limitations of the embodiments of the present invention. For those of ordinary skill in the art, other changes or alternations in different forms can also be made on the basis of the above description. It is not necessary and possible to list all of the embodiments herein. Any modifications, equivalent substitutions, improvements and the like made within the spirit and principles of the present invention shall be included in the scope of protection of the claims of the present invention.

What is claimed is:

1. A preparation method for a sulfur poisoning-resistant catalyst for catalytic combustion, comprising the following steps:
S1, separately dissolving a precious metal salt and a second metal salt in water to obtain a precious metal salt solution and a second metal salt solution;
S2, adding polyvinylpyrrolidone into a polyol to obtain a mixture, and simultaneously adding the precious metal salt solution and the second metal salt solution into the mixture to carry out a reaction to obtain a sol or a solution, wherein a molar ratio of a precious metal element in the precious metal salt solution to a second metal element in the second metal salt solution is (0.1-9):1; and
S3, fully mixing the sol or the solution obtained in the step S2, a catalyst carrier powder, and an organic solvent to load a precious metal component and a second metal component onto a catalyst carrier, and conducting drying and calcination to obtain the sulfur poisoning-resistant catalyst;
wherein the second metal salt is one or more of salts of Cu, Zn, Co, and Fe; and
the catalyst carrier is magnesia-alumina spinel.

2. The preparation method according to claim 1, wherein the precious metal salt is one or more of salts of Pt, Pd, Ru, Rh, and Au.

3. The preparation method according to claim 1, wherein the molar ratio of the precious metal element in the precious metal salt solution to the second metal element in the second metal salt solution in the step S2 is (0.428-2.3):1.

4. The preparation method according to claim 1, wherein a total loading amount of a precious metal and a second metal in the sulfur poisoning-resistant catalyst obtained in the step S3 is 0.1 wt %-1 wt %.

5. The preparation method according to claim 1, wherein a molar ratio of a magnesium element to an aluminum element in the magnesia-alumina spinel in the step S3 is 1:(2-3).

6. The preparation method according to claim 5, wherein a temperature of the calcination in the step S3 is 200-500° C.

7. A sulfur poisoning-resistant catalyst for catalytic combustion,
wherein the sulfur poisoning-resistant catalyst is prepared by the preparation method according to claim 1.

8. A method for treating a waste gas, comprising using the sulfur poisoning-resistant catalyst according to claim 7.

9. The method according to claim 8, wherein the waste gas is a sulfur-containing industrial organic waste gas.

10. The method according to claim 9, wherein a concentration of SO₂ in the sulfur-containing industrial organic waste gas is 1-200 ppm.

11. The sulfur poisoning-resistant catalyst according to claim 7, wherein in the preparation method, the precious metal salt is one or more of salts of Pt, Pd, Ru, Rh, and Au.

12. The sulfur poisoning-resistant catalyst according to claim 7, wherein in the preparation method, the molar ratio of the precious metal element in the precious metal salt solution to the second metal element in the second metal salt solution in the step S2 is (0.428-2.3):1.

13. The sulfur poisoning-resistant catalyst according to claim 7, wherein in the preparation method, a total loading amount of a precious metal and a second metal in the sulfur poisoning-resistant catalyst obtained in the step S3 is 0.1 wt %-1 wt %.

14. The sulfur poisoning-resistant catalyst according to claim 7, wherein in the preparation method, a molar ratio of a magnesium element to an aluminum element in the magnesia-alumina spinel in the step S3 is 1:(2-3).

15. The sulfur poisoning-resistant catalyst according to claim 14, wherein in the preparation method, a temperature of the calcination in the step S3 is 200-500° C.
